(19) United States
(12) Patent Application Publication
(10) Pub. No.: US 2010/0327606 A1
(43) Pub. Date: Dec. 30, 2010

(54) Energy Generation Systems and Processes

(76) Inventor: Larry Andrews, Spokane, WA (US)

Correspondence Address: WELLS ST. JOHN P.S., 601 W. FIRST AVENUE, SUITE 1300, SPOKANE, WA, 99201, US

(21) Appl. No.: 12/492,778

(22) Filed: Jun. 26, 2009

(51) Int. Cl. F02B 63/04

(52) U.S. Cl. 290/1 R

(57) ABSTRACT

The present disclosure provides energy generation systems that include a conduit loop having two portions with one portion being subterranean and the other portion being above ground. These systems can also include a power turbine coupled to both portions of the conduit loop and a pump coupled to both portions of the conduit loop. Processes for generating energy are also provided.

### TECHNICAL FIELD

The invention pertains to energy generation systems and processes.

### BACKGROUND

Currently it is becoming more and more important to conserve as much energy as possible. This conservation is being sought through various avenues. Example avenues are the exploitation of energy that is wasted in everyday use in commercial and residential applications. For example, there are opportunities to conserve and/or utilize energy where residential and/or commercial dwellings are heated or cooled during the winter and summer months. The present disclosure provides energy generation systems and methods that in some embodiments take advantage of these heating and cooling periods.

### SUMMARY

The present disclosure provides energy generation systems that include a conduit loop having two portions with one portion being subterranean and the other portion being above ground. These systems can also include a power turbine coupled to both portions of the conduit loop and a pump coupled to both portions of the conduit loop.

Processes for generating energy are provided that include providing two portions of a conduit loop wherein one of the portions is subterranean and the other of the portions is above ground. The process can further provide utilizing the expansive nature of the fluid to propel the turbine of a pressure differential turbine and the process can also include cooling the fluid in one of the portions of the conduit loop.

Processes for generating energy also include providing two portions of a conduit loop wherein one of the portions is within the foundation of the dwelling and the other of the portions is outside the dwelling. The process can further provide utilizing the expansive nature of the fluid to propel the turbine of a pressure differential turbine and cooling the fluid in one of the portions of the conduit loop.

### DRAWINGS

Embodiments of the disclosure are described below with reference to the following accompanying drawings.

FIG. 1 is an energy generation system according to an embodiment.

FIG. 2 is an energy generation system according to an embodiment.

FIG. 3 is an energy generation system according to an embodiment.

FIG. 4 is an energy generation system according to an embodiment.

### DESCRIPTION

This disclosure is submitted in furtherance of the constitutional purposes of the U.S. Patent Laws “to promote the progress of science and useful arts” (Article 1, Section 8).

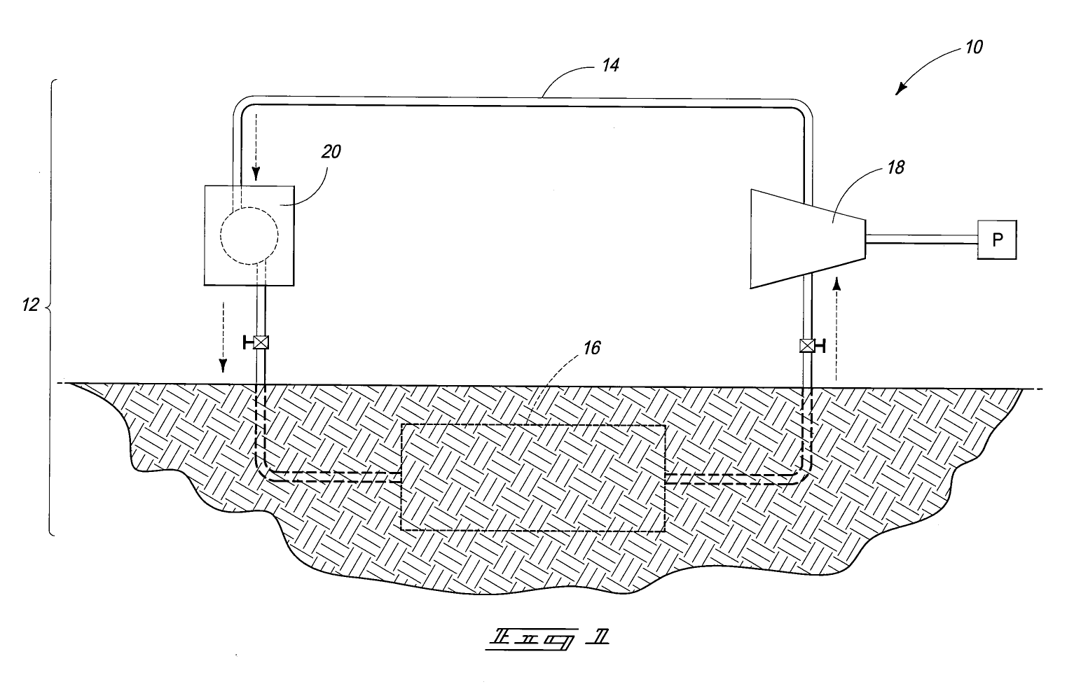

Energy generation systems and processes will be described with reference to FIGS. 1-4. Referring first to FIG. 1, an energy generation system 10 includes a conduit loop 12 having two portions, portion 16 being subterranean and a portion 14 being above ground. Portion 16 can include a tank or set of looped coil extending the residence time of fluid within the subterranean portion. This conduit loop can be a PVC pipe and/or metal pipe, for example. It can also be flexible tubing that can be provided to subterranean portions via horizontal drilling, for example. System 18 can include a power turbine coupled to both portions 14 and 16.

Power turbine 18 can be a pressure differential turbine, for example, such as a turbine that takes advantage of the expansive nature of a fluid. Example turbines include those turbines that can utilize the vapor pressure exhibited by a fluid when transitioning from the liquid state to the gaseous state. Example turbines can include low pressure turbines. Turbine suitable for utilization in the systems and methods of the present disclosure can include the BP-50 series offered by Trigen Ewing Power of Turner Falls Mass. These turbines can be purchased to utilize steam expansion but can easily be retrofitted with seals to allow for the use of refrigerant expansion such as the fluids described herein.

System 10 can also include a pump 20. Pump 20 can be an industrial size pump capable of removing fluid from loop portion 14 and providing it to loop portion 16. Referring again to power turbine 18, it can be configured to provide electric power.

According to example implementations, the fluid within loop 12 can include an expansive fluid such as a refrigerant. Example refrigerants can include hydrofluorocarbons and/or hydrofluorochlorocarbons. Example hydrofluorocarbons include HFC-125 and HFC-32. Example hydrofluorochlorocarbons include HCFC-22. Commercially available fluids such as R410A may be utilized as well.

According to example implementations, fluid within subterranean portion 16 for example can be cooled to its liquid or less entropic state and wherein the fluid can then be provided to an above ground portion 14 where it expands to propel turbine 18 and provide power. Upon expansion, the fluid can be provided away from portion 14 via pump 20 and returned to portion 16 where it again is condensed or returned to a less entropic state for recycling back to turbine 18. In this continuous fashion power can be generated utilizing the expansive nature of the fluid.

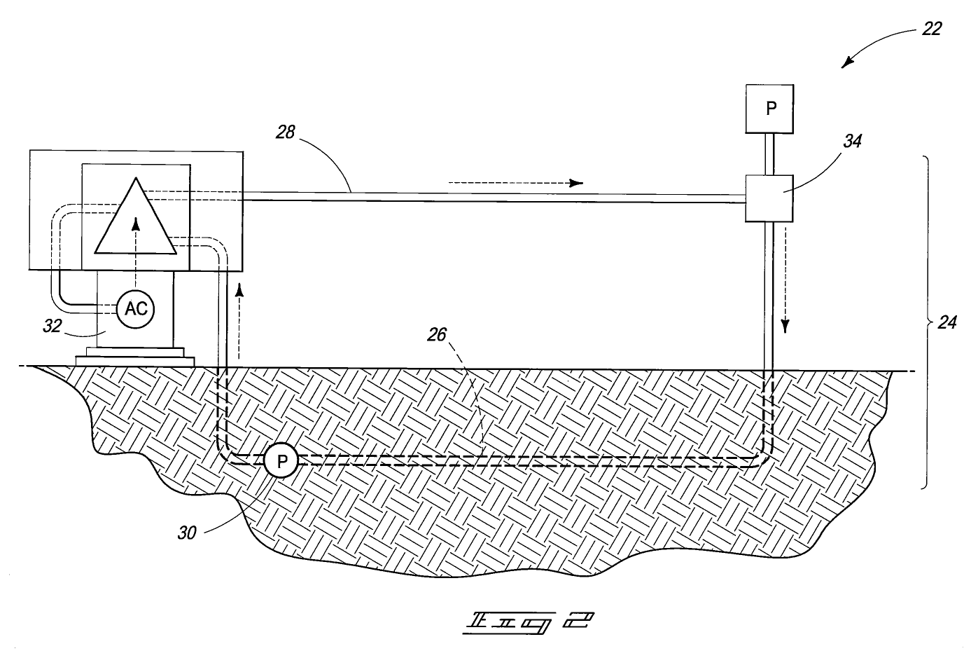

Referring to FIG. 2 system 22 is provided wherein loop 24 includes both a subterranean portion 26 and an above ground portion 28. In this embodiment, for example, fluid can be provided to within subterranean portion 26 and the flow of which is controlled via pump 30. Fluid may be provided proximate the exhaust of an air conditioning unit. According to example implementations, portion 26 can be within the foundation of a dwelling, for example a residential or commercial dwelling and it can be utilized to cool or heat fluid within that portion. According to other implementations, loop portion 28 can bypass AC unit 32 and provide for the cooling of fluid at the exterior of the home during winter months, for example. In this implementation cooling fluid can be provided to portion 26 where entropy can be increased and this increased entropy fluid can be provided to turbine 34, thereby providing power during both winter and summer months, for example.

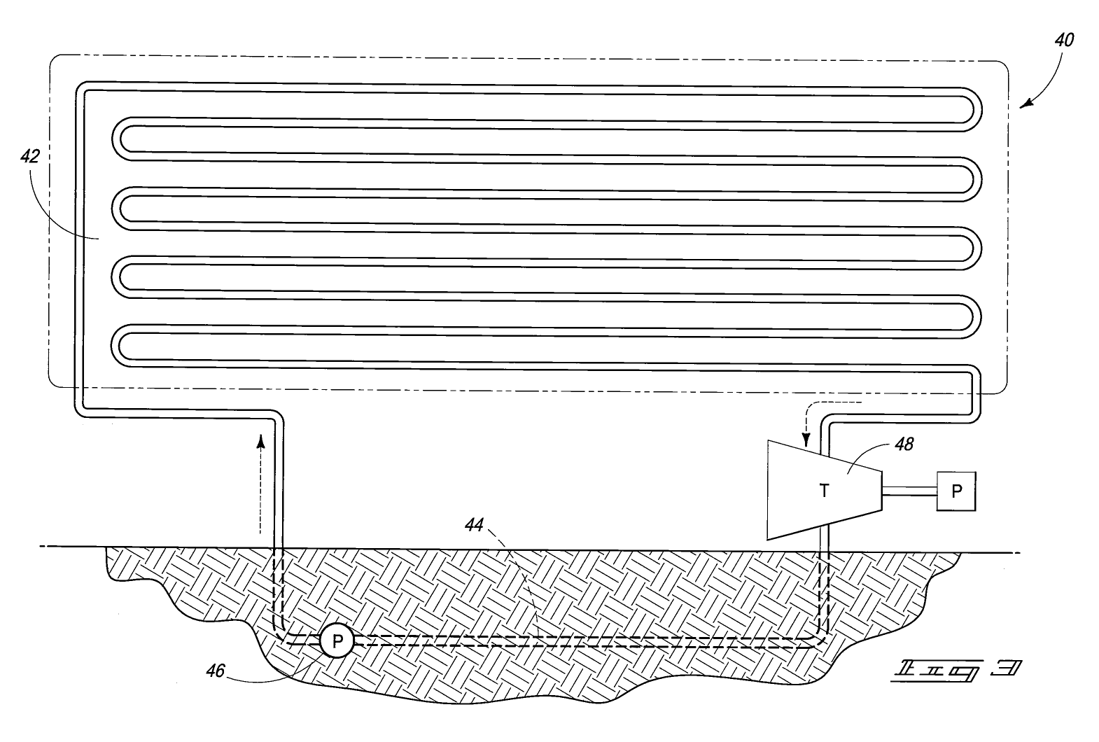

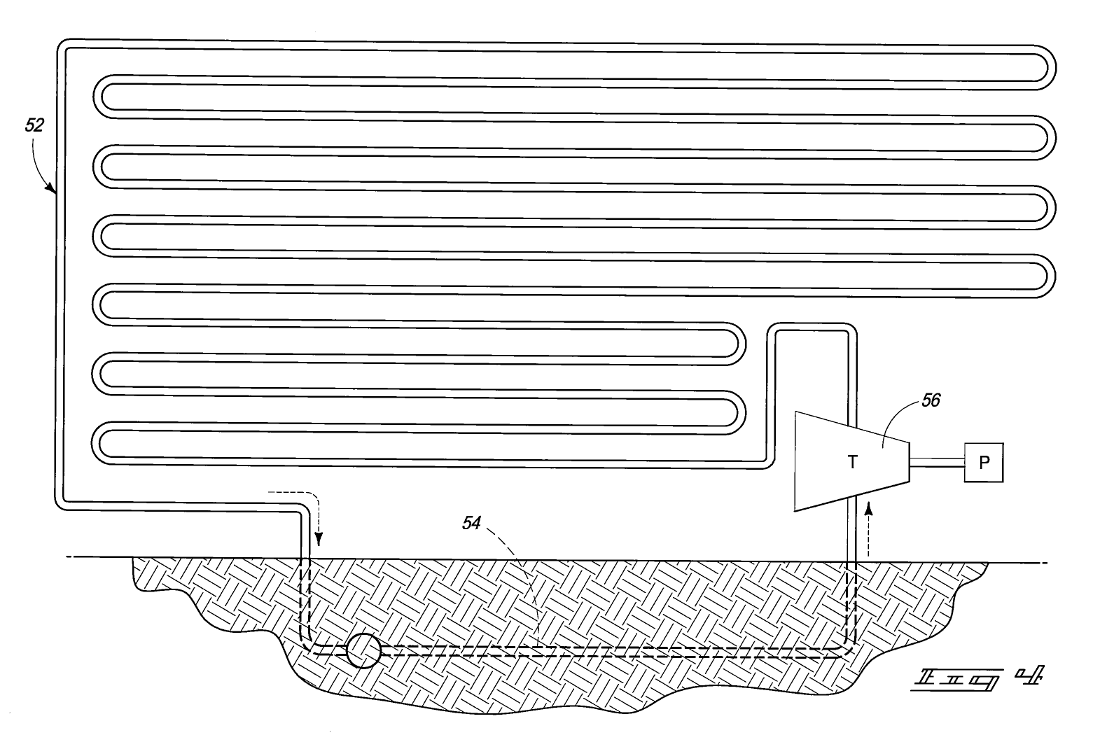

Referring to FIG. 3, another implementation system 40 is provided. System 40 can include a field of conduit 42 that is part of a loop with a subterranean portion 44. According to example implementations, between portions 44 and 42 can be turbine 48 as well as pump 46. When utilizing this configuration field 42 can be placed over a reflective material such as mirrors and/or white coating and the conduit of field 42 can be coated with a thermally absorptive material. Example thermally absorptive material can include dark colored paint, for example. According to example implementations fluid within system 40 can be provided to subterranean portion 44 where entropy is reduced and then provided to field 42 where entropy is increased. According to example implementations, field 42 can increase entropy to the vapor phase. Under this vapor phase this more highly pressurized fluid can run turbine 48 and generate power therefrom. Upon passing through turbine 48 fluid can be returned to portion 44 where entropy is reduced and the fluid returns to more of a liquid state than a vapor phase. Referring to FIG. 4 and according to another implementation, system 40 can be configured to provide a field of conduit 52 that exists during the winter months in a relatively cold atmosphere at a temperature that is much cooler than the subterranean temperature wherein portion 54 resides. According to this example implementation, fluid can be provided from region 52 where it is cooled to a low entropy state into subterranean portion 54 where the entropy state increases and this increased entropy state can be utilized to drive turbine 56.

In compliance with the statute, embodiments of the invention have been described in language more or less specific as to structural and methodical features. It is to be understood, however, that the entire invention is not limited to the specific features and/or embodiments shown and/or described, since the disclosed embodiments comprise forms of putting the invention into effect. The invention is, therefore, claimed in any of its forms or modifications within the proper scope of the appended claims appropriately interpreted in accordance with the doctrine of equivalents.

What is claimed is:

1. An energy generation system comprising:
a conduit loop having two portions, one portion being subterranean and the other portion being above ground;
a power turbine coupled to both portions of the conduit loop; and
a pump coupled to both portions of the conduit loop.

2. The system of claim 1 wherein the power turbine is configured to provide electric power.

3. The system of claim 1 wherein the above ground portion resides proximate fan exhaust of an air conditioning unit.

4. The system of claim 1 wherein the loop contains an expansive fluid.

5. The system of claim 1 wherein the loop contains a refrigerant.

6. The system of claim 1 wherein the loop contains a hydrofluorocarbon.

7. The system of claim 1 wherein the loop contains a hydrofluorochlorocarbon.

8. The system of claim 1 wherein the loop contains HFC-125.

9. The system of claim 1 wherein the loop contains HFC-32.

10. The system of claim 1 wherein the loop contains HCFC-22.

11. A process for generating energy, the process comprising:
providing two portions of a conduit loop, wherein one of the portions is subterranean and the other of the portions is above ground;
utilizing the expansive nature of the fluid to propel the turbine of a pressure differential turbine; and
cooling the fluid in one of the portions of the conduit loop.

12. The process of claim 11 wherein the other of the portions of the loop is a grid of the conduit extending over a reflective material.

13. The system of claim 12 wherein the grid of conduit is coated with a thermal absorption material.

14. The system of claim 13 wherein the thermal absorption material is a dark colored paint.

15. The process of claim 12 wherein the fluid is cooled within the subterranean portion of the loop.

16. The process of claim 11 wherein the other of the portions of the loop is grid of conduit.

17. The process of claim 16 wherein the fluid is cooled within the grid.

18. The process of claim 11 wherein the other of the portions of the loop extends above an exhaust of an air conditioning unit.

19. A process for generating energy, the process comprising:
providing two portions of a conduit loop, wherein one of the portions is within the foundation of a dwelling and the other of the portions is outside the dwelling;
utilizing the expansive nature of the fluid to propel the turbine of a pressure differential turbine; and
cooling the fluid in one of the portions of the conduit loop.

20. The process of claim 19 wherein the fluid is cooled in the portion of the loop within the foundation of the dwelling.
